(19) United States
(12) Patent Application Publication
(10) Pub. No.: US 2003/0126214 A1
(43) Pub. Date: Jul. 3, 2003

(54) Document management system

(76) Inventor: Mike Oliszewski, Tigard, OR (US)

Correspondence Address: Kevin L. Russell, Suite 1600, 601 SW Second Ave., Portland, OR, 97204-3157, US

(21) Appl. No.: 10/208,062

(22) Filed: Jul. 29, 2002

Related U.S. Application Data
(60) Provisional application No. 60/327,376, filed on Oct. 4, 2001.

(51) Int. Cl. G06F 15/16

(52) U.S. Cl. 709/206; 709/246

(57) ABSTRACT

A document system that decreases the likelihood of receiving a virus.

### CROSS-REFERENCE TO RELATED APPLICATION

This application claims the benefit of U.S. Provisional Application No. 60/327,376, filed Oct. 4, 2001.

### BACKGROUND OF THE INVENTION

The present invention relates to a document management system.

Systems that support the exchange of text messages among users often allow files to be attached to messages. As one example, electronic mail (i.e., email) may have an attachment that is a word processing document, or an audio, video, or graphics file. As another example, a download of a message from a web site on the World Wide Web may include an attached text file in Hypertext Markup Language (HTML) or an attached audio, video, or graphics file.

Messages may be transmitted from a sending client device (such as a computer) or from a remote server (such as a web server) to a message transport server that supports a computer or other client device from which the receiving party attempts to access the message. In an email environment, a sending party may generate an email message at a first computer that transmits the message to a first email server. If the first email server does not support message access for the party to whom the message is directed, the first email server forwards the message to a second email server that supports access by the receiving party. The message is stored at the second server for download by the receiving party.

Such message exchange systems typically operate seamlessly for messages that do not include file attachments, since the systems are designed for sending embedded text. Many e-mail systems are basically an ASCII text system. However, difficulties arise when a message includes an attached file. Seamless access to the attached file may be inhibited by decoding-specific requirements or application-specific requirements upon the receiving client device. Regarding the decoding-specific requirements, attached files are typically encoded to accommodate transmission within a network, such as the Internet. There are different available protocols for accomplishing the encoding. One such protocol is Multimedia Internet Mail Extensions (MIME), which converts the attached files to text and sends the converted text within the message. The converted text is then reconverted to its original form at the receiving client device. Other well known standards include, for example, UUencode and BinHex. At the receiving client device, the same encoding standard should be used to decode the attached file, if the file is to be properly accessed.

Even if the attached file is properly decoded at the receiving client device, the file will not be accessible unless the client device has the required application program for opening the attached file. Typically, an attachment has a file format that is specific to an application. For example, an email attachment of a word processing text file may be specific to a particular word processing program. Access to the text is possible only if the receiving client device includes the program or has the capability of converting the decoded file to another file format that is accessible. Video, audio and graphics files typically have more exacting demands. For example, an AVI video formatted file is not converted to a MPEG video formatted file without significantly more complexity than the process of converting from one application-specific word processing file format to a second application-specific word processing file format.

Many client devices have the capability of converting attachments from a limited number of inaccessible file formats to an acceptable format. For example, Microsoft Word is capable, to a limited extent, of importing Corel WordPerfect files. If the attachment is a relatively short word processing document, this capability in some cases is all that is required for efficient display of the document at the receiving client device. However, if the attached file is large, such as an intra-corporation multimedia presentation of a new product release, the required time to convert the attachment between file formats may lead to a significant inefficient use of the time of corporate personnel. Particularly in the conversion of multimedia file attachments, a complex algorithm must be utilized. In addition, the conversion programs are likewise limited in their ability to convert non-native files. Accordingly, complicated documents created by a first application, such as Microsoft Word file, may not be presented properly or even open in many cases, when opened by Corel WordPerfect.

Thus, if a file attachment is received that requires an application that is “foreign” to the receiving computing device, the first issue is whether the computing device is capable of converting the attachment to an accessible file format. A second issue relates to the time requirements of the conversion process, if a conversion is executable. A third issue relates to the reliability of the conversion operation. Often, the conversion causes data loss.

The generation and spread of computer viruses is a major problem in modern day computing. Generally, a computer virus is a program that is capable of attaching to other programs or sets of computer instructions, replicating itself, and performing unsolicited or malicious actions on a computer system. Generally, computer viruses are designed to spread by attaching to floppy disks or data transmissions between computer users, such as an e-mail attachment, and are designed to do damage while remaining undetected. The damage done by computer viruses may range from mild interference with a program, such as the display of an unwanted political message in a dialog box, to the complete destruction of data on a user's hard drive. It is estimated that new viruses are created at a rate of over 100 per month.

A variety of programs have been developed to detect and destroy computer viruses. As is known in the art, a common method of detecting viruses is to use a virus scanning engine to scan for known computer viruses in executable files, application macro files, disk boot sectors, etc. Generally, computer viruses are comprised of binary sequences called “virus signatures.” Upon the detection or a virus signature by the virus scanning engine, a virus disinfection program may then be used to extract the harmful information from the infected code, thereby disinfecting that code. Common virus scanning software allows for boot-sector scanning upon system bootup, on-demand scanning at the explicit request of the user, and/or on-access scanning of a file when that file is accessed by the operating system or an application.

In order to detect computer viruses, a virus scanning engine is generally provided in conjunction with one or more files called “virus signature files”. The virus scanning engine scans a user's computer files via a serial comparison of each file against the virus signature files. Importantly, if the signature of a certain virus is not contained in any of the virus signature files, that virus will not be detected by the virus scanning engine.

A leading antivirus application, produced by McAfee Associates, is called VirusScan(TM). In one form, the VirusScan(TM). application is adapted for use on a user's client computer running on a Windows 95(TM). platform. A main routine used by this antivirus application is “SCAN.EXE”, a program file that is typically placed in the directoryC:.backslash.PROGRAM.sub.—FILES.backslash.MCAFEE.backslash.VIRUSSCAN on the user's hard drive. The program SCAN.EXE is adapted to be used for any of the following types of virus scanning: virus scanning of system boot-sectors at startup, on-demand virus scanning at the explicit request of the user, and on-access virus scanning of a file when that file is accessed by the operating system or an application. In the Windows 95(TM). environment, the Registry files are often modified such that SCAN.EXE is run at computer startup, and also remains resident for scanning all files upon file access.

In a typical configuration, VirusScan(TM). is used in conjunction with a set of virus signature files having the names CLEAN.DAT, MCALYZE.DAT, NAMES.DAT, and SCAN.DAT. As of McAfee's Oct. 15, 1997 release of version 3010 of its VirusScan(TM). signature file updates, these virus signature files collectively comprise over 1.6 MB of virus information. In a typical configuration, the files CLEAN.DAT, MCALYZE.DAT, NAMES.DAT, and SCAN.DAT are also placed in the directory C:.backslash.PROGRAM.sub.—FILES.backslash.MCAFEE.backslash.VIRUSSCAN on the user's hard drive.

For purposes of clarity and simplicity in describing the background and preferred embodiments, this disclosure will refer to a generic antivirus program “Antivirus.sub.—Application.exe” and a generic antivirus signature file VIRUS.sub.—SIGNATURES.DAT. Generally speaking, a recent trend is for manufacturers of antivirus applications to update their virus signature files VIRUS.sub.—SIGNATURES.DAT as new viruses are discovered and as cures for these viruses are developed, and to make these updated signature files available to users on a periodic basis (e.g. monthly, quarterly, etc.). For example, an antivirus program manufacturer may post the update file VIRUS.sub.—SIGNATURES.DAT on a bulletin board system, on an FTP (File Transfer Protocol) site, or on a World Wide Web site for downloading by users.

FIG. 1 illustrates one serious problem that arises from the constant onslaught of new viruses. FIG. 1 shows a flowchart of steps 100 which can occur when a typical user purchases and loads an antivirus program equipped with virus signature files, but neglects to keep its virus signature files current. At step 102, on a first date such as April 1, Year 0 (Apr. 1, 2000), the user acquires and loads the antivirus application Antivirus.sub.—Application.EXE and the signature files VIRUS.sub.—SIGNATURES.DAT, the file VIRUS.sub.—SIGNATURES.DAT having a last-revised date, for example, of Feb. 1, 2000. At step 104, the Antivirus Application.exe routine and the VIRUS.sub.—SIGNATURES.DAT file are successfully run on the user's computer. The user, being satisfied that he or she has adequately protected the computer, does not update the VIRUS.sub.—SIGNATURES.DAT file.

However, in the meantime, as shown in FIG. 1 at step 106, on May 15, 2000 a third-party “hacker” develops and begins the distribution and spreading of BAD.sub.—APPLE.V, a new virus which replicates itself and destroys user data. At step 108, on Jul. 15, 2000, the antivirus manufacturer who makes Antivirus.sub.—Application.exe discovers BAD.sub.—APPLE.V. At step 110, that day the manufacturer develops a fix for BAD.sub.—APPLE.V and writes its virus signature (along with data to implement the fix) into the next release of VIRUS.sub.—SIGNATURES.DAT. At step 112, the antivirus manufacturer releases an updated VIRUS.sub.—SIGNATURES.DAT dated Sep. 1, 2000. In addition to containing other virus signatures and fixes, the new VIRUS.sub.—SIGNATURES.DAT file contains the virus signature and fix for BAD.sub.—APPLE.V.

At step 114, on Jan. 13, 2001, the user from step 104 finally becomes infected by the BAD.sub.—APPLE.DAT virus. For example, the user may have borrowed a floppy disk infected with BAD.sub.—APPLE.V from a friend, or may have downloaded an application infected with BAD.sub.—APPLE.V from the Internet. At that very time, at step 116, the program Antivirus.sub.—Application.exe scans the infected program. However, at step 116 the BAD.sub.—APPLE.V virus goes undetected by Antivirus.sub.—Application.exe because the VIRUS.sub.—SIGNATURE.DAT file being used is an old one dated Feb. 1, 2000, and therefore it does not contain the virus signature for BAD.sub.—APPLE.V. Because it has remained undetected, at step 118 on Jan. 19, 2001, the BAD.sub.—APPLE.V virus destroys data on the user's computer.

The scenario of FIG. 1 is a common manner in which desktop systems that are purportedly “protected” from infection nevertheless become infected by new viruses, and represents a problem unique to computer antivirus applications. Upgrades to antivirus files generally have no effect on the user's usage of the desktop system. As represented by the scenario of FIG. 1, the need for antivirus upgrades is often not realized by a user until it is too late. In another common scenario, the virus scanning Antivirus.sub.—Application.exe may itself be outdated, having been superseded by a newer and superior engine. These outdated engines are often unable to detect the new species of viruses, which are constantly evolving, such as “stealth” viruses and “polymorphic” viruses.

Unfortunately, even if the user is comparatively sophisticated in his or her ability to maintain the most recent virus scanning engines and virus signature files, preventable virus infection may still occur. With the proliferation of users on the Internet and World Wide Web, new viruses may be spread almost instantaneously upon their introduction. Unless the user affirmatively checks up on the manufacturer's new releases daily, his or her system may not be protected with the most recent virus signature files and scanning routines available.

FIG. 2 illustrates another practical problem that may arise regarding antivirus software distribution, this time in the context of a typical corporate local area network (LAN). FIG. 2 shows a typical local area network 200 comprising a network server 202, a communications network 204 such as an ETHERNET network, a plurality of user nodes 206A-206N, and an Internet gateway 208. As known in the art, Internet gateway 208 is generally coupled via an appropriate protocol connection to the Internet 210, either through an ISP (Internet Service Provider) or a dedicated connection to the Internet 210.

In a common scenario associated with the environment of FIG. 2, one or more dedicated system administrators 212 have the task of ensuring that the antivirus software on the local desktop machines 206A-206N stays updated. Thus, in the environment of FIG. 2, there are additional layers of complexity associated with the updating of desktop antivirus software in comparison to the single user scenario. In particular, the system administrator 212 must (a) maintain an awareness of all antivirus software needs of the various user nodes 206A-206N, (b) maintain an awareness of all update information relating to the antivirus software, and (c) retrieve and install the latest versions and updates for each user node as soon as those updates become available. While modern antivirus updating systems may allow the system administrator 212 to manually request and receive updates from an antivirus manufacturer FTP or World Wide Web Site 214 across the Internet 210, as shown in FIG. 2, it is nevertheless a labor-intensive task to distribute and install the antivirus updates effectively and rapidly. The antivirus update collection and distribution tasks can readily become difficult to keep up with, especially where a typical corporate network may have a variety of hardware platforms (e.g., IBM, MacIntosh, Sun, Silicon Graphics), and a variety of software platforms (e.g., Windows 95, Windows 3.1, DOS, LINUX, UNIX, MacIntosh), each combination of which will have its own unique set of virus scanning engines and virus signature files. It is well known in the art, for example, that viruses are operating system specific, and so the local client computers 206A-206N of FIG. 2 will likely require several different virus scanning engines and virus signature files. Each of these product lines will likely have distinct and disparate updating schedules, further frustrating the efforts of the system administrator 212.

Accordingly, it would be desirable to provide a system for providing the most up-to-date virus scanning and disinfection on a user's computer for protecting against the newest viruses. It would be further desirable to provide a method and system for the antivirus software updating to be simple and automatic, such that unsophisticated users are consistently provided with the most recent antivirus protection available. It would be even further desirable to provide a method of antivirus software update distribution which allows a higher frequency of update releases from antivirus software manufacturers for the most up-to-date, or even up-to-the-hour, antivirus protection available. It would be even further desirable to provide a method of automated antivirus software update distribution to the different types of user nodes of a local corporate network, with minimized intervention required by the system administrator.

Systems exist for the transmission and distribution of facsimile documents across networks. However, facsimile documents result in a paper output and inherently do not have viruses, nor significant compatibility issues because most facsimile devices use international standards. Such systems include, for example, Okada, U.S. Pat. No. 6,101,548; Toyoda et al., U.S. Pat. No. 6,124,939; Sekiguchi et al., U.S. Pat. No. 6,141,695; and Saito, U.S. Pat. No. 6,128,101.

Portable document format (PDF) is a file format currently distributed by Adobe Systems, Inc. of San Jose, Calif. which is utilized to represent a document in a manner independent of the application software, hardware and operating system used to create it. A document is converted into a PDF document/data by a PDF writer. A PDF document/data contains one or more pages, each page in the document containing a combination of text, graphics, and/or images and may also contain information such as hypertext links, sound, and movies. A user may view and edit a PDF document/data through a graphical user interface (GUI) provided by a PDF viewer application. Because of the proprietary nature of the PDF file format and the proprietary nature of the associated viewer, documents transferred between individuals in a PDF file format are typically free from computer viruses. Unfortunately, the PDF file format is based upon postscript and results in excessively large documents. Further, to create a PDF file typically requires purchasing a PDF creation program, at substantial expense. Moreover, for each individual of an organization to have the ability to create a PDF document requires the purchasing of the PDF creation program for each desktop, at substantial expense, or otherwise burdening one or more individuals with the task of creating PDF files on behalf of others, which is inconvenient. For example, the creator of the document may transfer the file to another person in the organization, the other person may create the PDF file from the document and transfer the PDF file back to the creator of the document, then the creator of the document may use the PDF file as desired, such as e-mail, publishing on the Internet, or storage.

### BRIEF DESCRIPTION OF THE DRAWINGS

FIG. 1 is a flow chart of antivirus protection.

FIG. 2 is an illustration of antivirus software distribution.

FIG. 3 is an exemplary embodiment of a document conversion process of the present invention.

FIG. 4 is an originating e-mail.

FIG. 5 is an exemplary alternative embodiment of a document conversion process of the present invention.

FIG. 6 is an exemplary further alternative embodiment of a screen capture technique.

FIG. 7 is a viewer for a portable document.

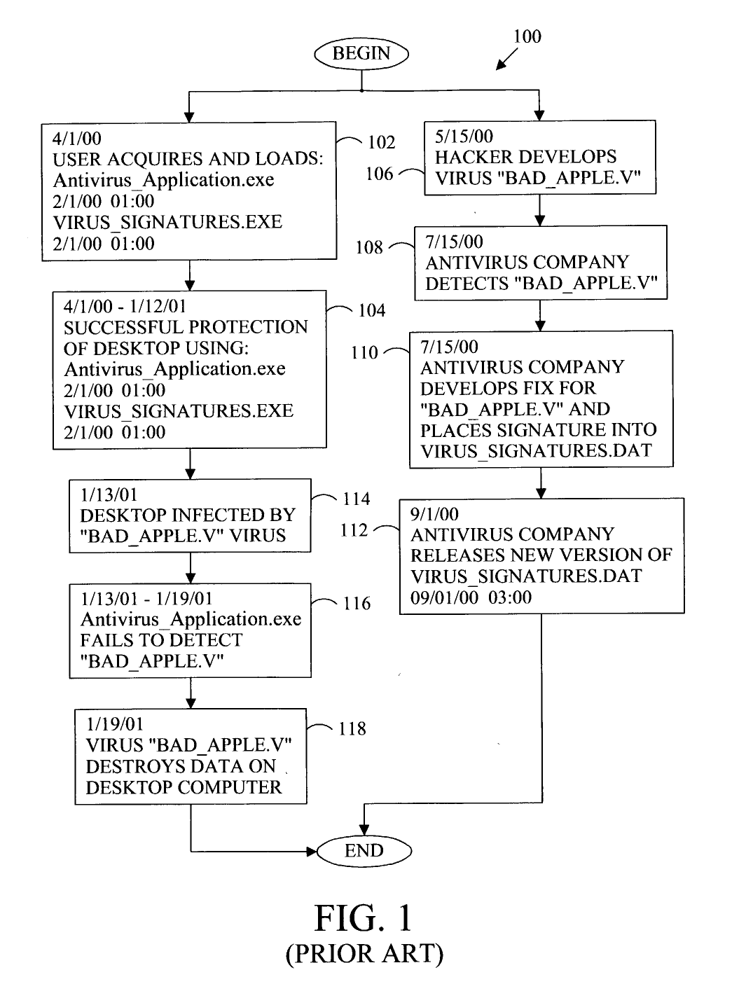

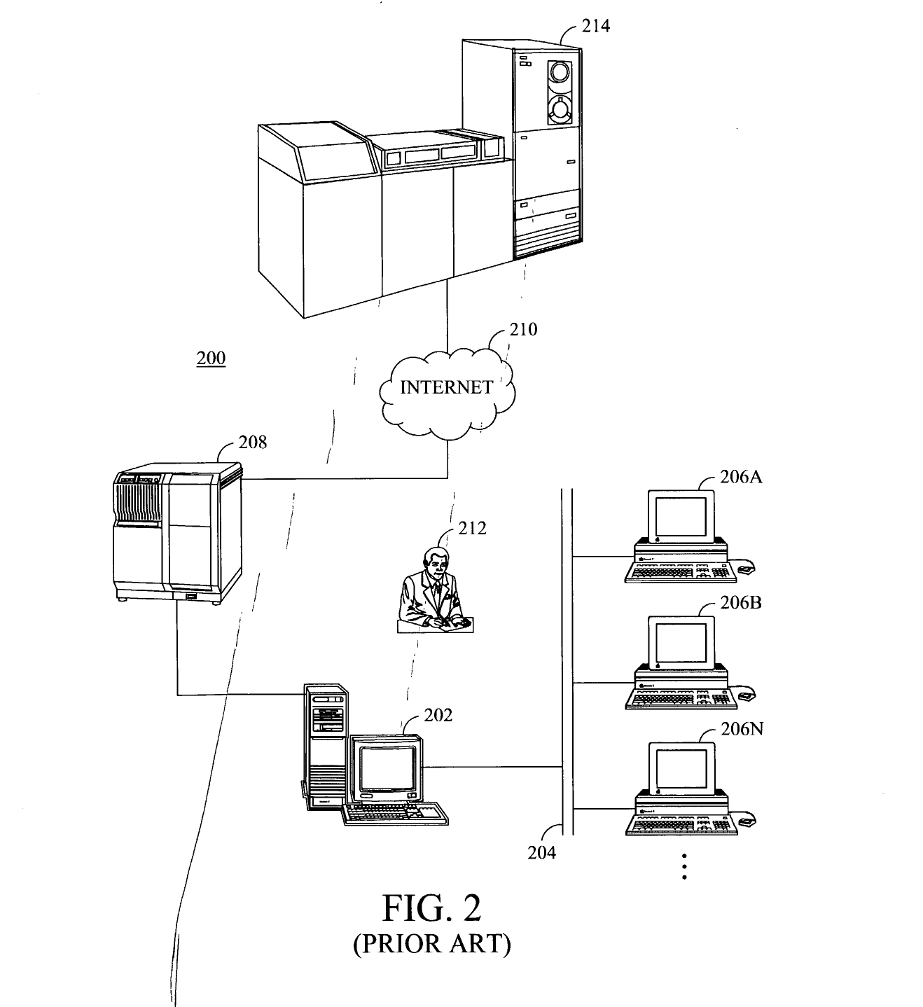

### DETAILED DESCRIPTION OF THE PREFERRED EMBODIMENT

An attempt has been made by Shaffer et al., U.S. Pat. No. 6,092,114, to provide a solution to the problem of exchanging electronic messages, such as e-mail messages, which includes isolating personal computers and other client devices from the process of converting a message attachment from one file format to a second file format. File-format conversions are out-tasked. The access requirements of each attachment to electronic messages are compared to the capabilities of a target client device. If it is determined that a file-format conversion is required, the conversion operation is assigned to a server that supports the process of reformatting the attachments. In an email environment, the server is substantially equivalent to the conventional email server, but includes enhanced conversion capabilities. In one embodiment, the determination of whether an attachment is accessible without conversion occurs at the server level. In another embodiment, the determination is implemented at the client device level. Preferably, if a local email server is incapable of reformatting the attachment, a request is transmitted to a remote server to perform the conversion. Typically, the remote server is the email server that supports message exchanges for the person who originated the message.

The system taught by Shaffer et al., is utilized to provide file-format conversion of an attachment to a message sent from one of the local client devices 14, 16, and 18 to another one of the local client devices or otherwise to another client device across a network, such as the Internet. In particular, the e-mail server associated with the sending user checks the file-format of the attachment against a database, namely an application register, that includes information as to whether or not the file format of the attachment should be modified for the target client device. If file-format conversion is required for the particular target client device, the conversion is performed. In this manner, Shaffer et al., teach an out-bound e-mail attachment conversion system by which the sending user does not need to be aware of the target client capabilities because the e-mail server associated with the sending user keeps track of the target client capabilities, and performs the conversion, if necessary. However, the present inventor came to the realization that the e-mail server associated with the sending user that tracks the acceptable file formats for each particular target client becomes difficult when the target client changes capabilities. In addition, when the target client changes capabilities, these are not necessarily reported to the e-mail server, in which case the file may not be converted when it should be or the file may be converted to a format that is incompatible with the particular target device. Further, the present inventor came to the realization that if a computer virus is present in the e-mail attachment, the conversion process does not scan for viruses or otherwise remove them. For example, an attachment with a virus may be forwarded by the e-mail server, or the file converted to another format with the virus remaining intact and thereafter forwarded with the converted file.

Guck, U.S. Pat. No. 5,911,776, discloses a network providing a server using an object-database enables an author to create and store an original document, as a source file with a first format. Software in the data base will provide multiple sets of shadow file-converter groups connected to the source file of the original document. Each shadow file-converter set enables the transformation of the original source file format into a particular other specific type of format. Any client or user of the network can access and receive a copy of the original source document which is automatically reformatted to match the requirements of the receiver's appliance. Thus, one original source document can be created and then published in any specific format to multiple numbers of and type of receiving appliances. The system taught by Guck requires knowledge by the server of the particular format that the designated device requires, which may not be always available, so that the appropriate conversion may be done. Guck, U.S. Pat. No. 5,848,415 discloses a similar system.

Pearson et al., U.S. Pat. No. 5,627,997, discloses a system for converting the format of computer mail messages using a dynamic set of conversion routines. In a preferred embodiment, a message format conversion engine uses an updatable registry to access an extensible set of available conversion routines. The registry contains selection information and invocation information for each of the available conversion routines. The selection information in each case describes the classes of messages that the conversion routine is potentially capable of converting. The invocation information comprises information necessary to invoke the conversion routine. When a message is submitted to the conversion engine, the engine reads the selection information stored in the registry. The engine then uses the read selection information to select one of the available conversion routines likely to be capable of converting the message. The engine reads the invocation information stored in the registry for the selected conversion routine and uses it to invoke the selected conversion routine to convert the format of the message. In a further preferred embodiment, the conversion engine invokes the selected conversion routine in two stages. The engine first invokes a query method of a selected conversion routine, which indicates whether the selected conversion routine is actually capable of converting the message. If the invocation of the query method indicates that the selected conversion routine is actually capable of converting the message, then the engine invokes a convert method of the selected conversion routine in order to convert the format of the message. However, the system disclosed by Pearson et al. only relates to the message envelope for modification of the format of computer mail messages and not to the conversion of any files.

Falker, U.S. Pat. No. 5,894,558, discloses a system for dispatching documents, wherein the documents are first converted from a customer-specific data format to a standardization data format, and only then deciding by means of decision logic using the document in the standardized data format, whether the document is further transmitted to the recipient as an electronic document, or whether it is converted from the standardized to a postal data format in a converter station. The converter station then dispatches the document to a postal service printing center in the area where the recipient is located. There the document is printed out and directed for delivery by postal service personnel. The system taught by Falker presumes that everyone can not use the same file format so the system determines what format is needed and converts it to that file format.

After consideration of the aforementioned systems, the present inventor came to the startling realization that the file compatibility issues may be alleviated by using a different paradigm. The new paradigm is not based on attempting to determine the appropriate file format for outgoing files from the originating user, and the originating user or server associated therewith formatting the file in an appropriate manner for the destination device, but in contrast the new paradigm is based upon reformatting received files to a common file format suitable for viewing on the destination device. Reformatting received files by a server on behalf of the destination user, or reformatting the received files by the destination user, to a common file format eliminates the need of the originating user to know the characteristics of the destination user's device, which may change without notice to the originating user. For example, the inbound e-mails may be characterized by, for example, an e-mail message where the originator of the e-mail does not use the e-mail server (or group of associated e-mail servers) as his outgoing e-mail server. Further, by using a common file format for the file conversion, the system does not need to query the destination user for the desired destination format for a particular received file format nor determine the appropriate file format for a particular received file format suitable for a particular user.

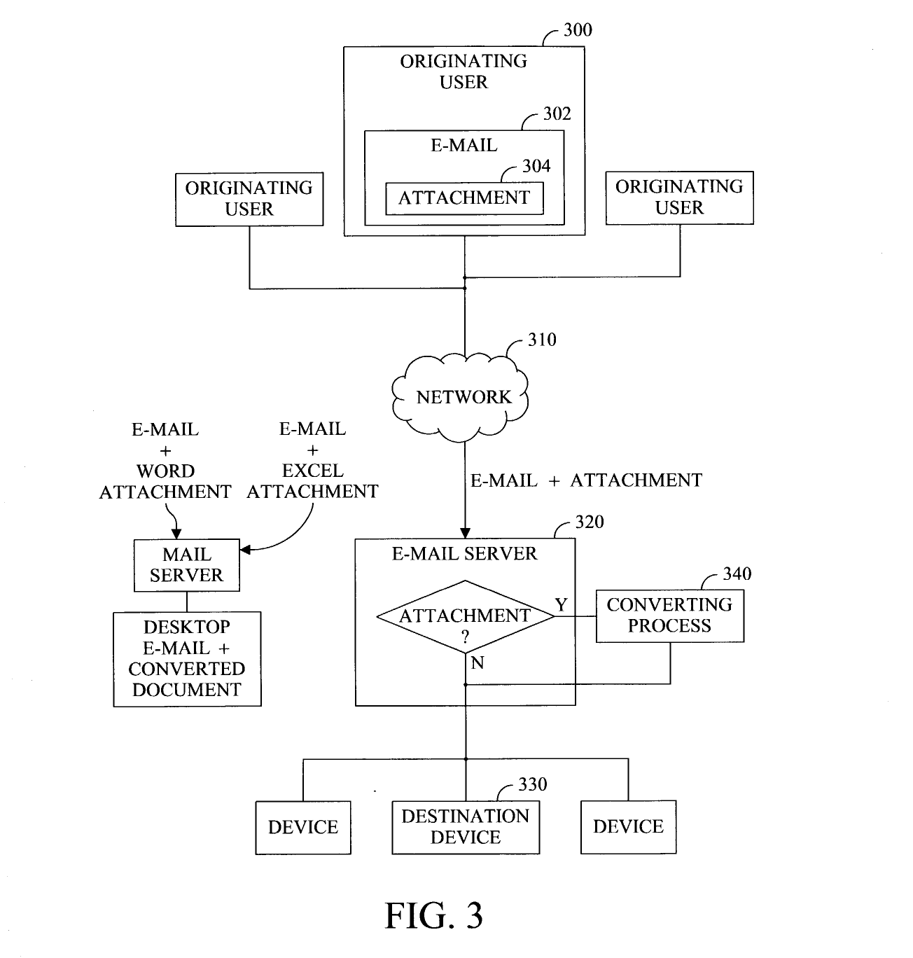

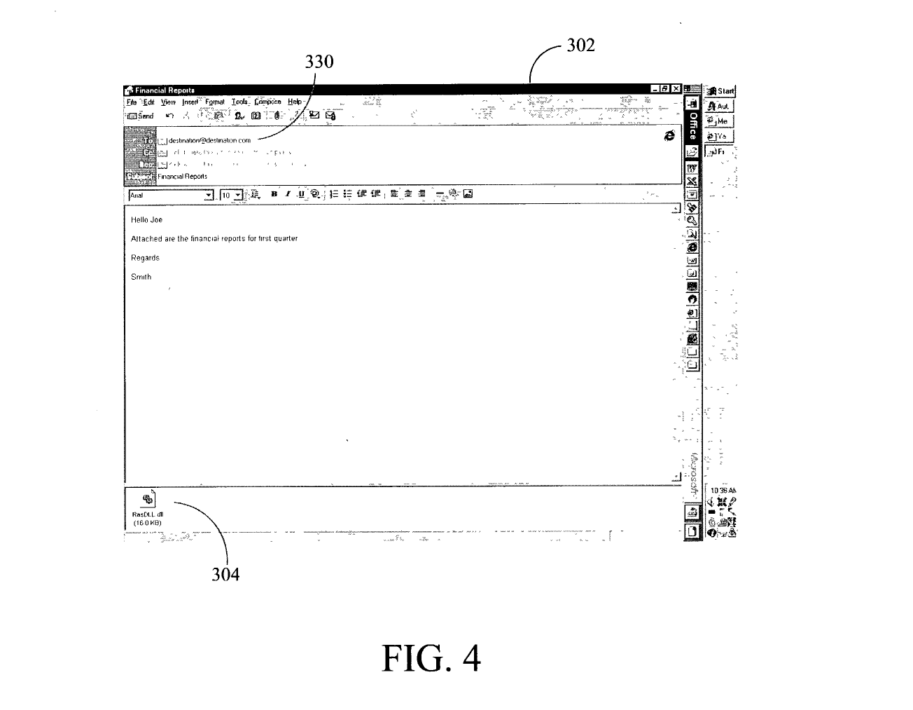

Referring to FIG. 3, the originating user 300 may create and/or send an e-mail message 302 to a destination user(s) together with an attachment 304. The e-mail message 302 may be encoded, formatted, and transmitted in any desired manner. The transmission of the e-mail together with the attachment from the originating user 300 to the destination user 330 may be across any network 310, such as the Internet, a local area network, a wide area network, between one or more interconnected computers, within the same computer, or otherwise. The attachment 304 may be any type of file that is associated with the e-mail, whether provided together with the e-mail 302 itself or otherwise the e-mail 302 indicates the location thereof of the file if not provided with the e-mail itself. For example, the e-mail may indicate the location of the attachment, such as a location accessible through the network 310.

An e-mail server 320 receives the e-mail 302 together with the attachment 304. When the e-mail server 320 detects an attachment 304 associated with the e-mail 302, the attachment 304 is preferably automatically routed, preferably free from determining of the type of attachment unless it is the format of the document to which the file will be converted to, to a converting process 340. The converting process 340 preferably opens the attachment 304 using an appropriate software program for the particular attachment. For example, if the attachment is determined to be a Microsoft Word document then the attachment may be opened with Microsoft Word. For example, if the attachment is determined to be a Corel WordPerfect document then the attachment may be opened with Corel WordPerfect instead. In this manner, the appropriate program may be used to open the documents, which helps insure proper reading of the attachment. In addition, general purpose programs that are suitable for opening hundreds, if not thousands, of different file formats (or otherwise attachments) may likewise be used. In the preferred system, all of the attachments that are converted, many of which may have different originating file formats, are converted to the same file format. Converting to the same file format normally permits them to be viewed by the same viewer. Moreover, the conversion process is preferably performed without checking the destination user, the destination device, or otherwise a data structure to determine what format the converted attachment should be in. Also, the conversion process may be performed by the e-mail server, a computer or process associated with the e-mail server, another computer or process located somewhere on the network, the destination computer, or otherwise. If the conversion process is not performed by the user's computer then the user's time is not wasted for the file conversion. Moreover, having a centralized file conversion process tends to result in greater reliability.

After opening the attachment 302, the attachment is then preferably converted to a common file format. The e-mail envelope may be converted, if desired. While the converted file format does not necessarily need to be a common file format, it is preferably to use a common file format so that a single viewer may be installed on the destination device suitable to view all converted files. The preferred technique for conversion of the document to a common file format is to print the document to a suitable printer driver, such as for example, postscript, PCL, Windows GDI, or otherwise. The data stream to the printer driver, data stream within the printer driver, or from the printer driver provides a readily usable page description layout description of the viewable contents of a particular attachment, namely, data representative of the page layout of the document as it would appear on the particular printer. In this manner, the converting process may be designed in a manner that is typically independent of the particular file format of the attachment. In addition, when a new software program is released, or otherwise a new version of an existing software program is released, the updating process for the converting process is merely installing the new software on the e-mail server or an associated computer of the converting process so that attachments associated with the new computer software are opened by the new computer software and thereafter printed. This avoids the need to parse or otherwise determine the exact file format used by each computer software program and version thereof, which tends to change over time, with or without notice. The attachment is modified to a common file format suitable for viewing by the particular destination device with an viewer. For example, if the converting process modifies the attachments to a PDF file format suitable for Adobe Acrobat Viewer, then the original e-mail attachment may be replaced by the PDF file and the e-mail together with the attachment may be forwarded or otherwise made available to the destination device. In this manner, the destination device does not need to install the latest computer software for every conceivable file format that may be received. This results in a substantial savings in the necessary software that needs to be purchased or otherwise licensed. Further, the destination user does not need to attempt to open a document that is in a format that may not be adequately supported by the software that the destination user currently has. For example, if the attachment is in version 5.0 of Microsoft Word and the user has version 7.0 of Microsoft Word, the attachment does not need to be converted from version 5.0 to version 7.0, which may result in inappropriate formatting. Instead, the converting process may have appropriate computer software for opening version 5.0 resulting in an appropriate output, especially if processed through the printer pipeline. It is to be understood that any other suitable file format conversion mechanism may likewise be used, as desired.

After consideration of the document conversion system with respect to in-bound e-mail messages, the present inventor also came to the realization that this may result in the elimination of computer viruses. Since the preferred file format is a page description that merely contains data, without any active program elements, the converted files are free from computer viruses. Accordingly, in addition to the benefits of reducing file format incompatibilities, the implemention of such a system would likewise result in the elimination of a major threat to networked computer systems, namely, computer viruses spread through e-mail attachments. Further, with the automatic conversion of all incoming documents to a non-virus susceptible format, the users will not inadvertently trigger a computer virus causing major damage and disruption. Further, there is no inherent delay in the system by waiting until a virus is detected, a detection model developed, the virus detection model deployed to the server, and the viruses thereafter detected. The conversion paradigm for virus elimination is always current, by the nature of the conversion process. In other words, this technique of elimination of viruses is not a reactive process, but rather a proactive process. The resulting converted file may be viewed by an appropriate viewing program installed or otherwise made available on the user's computer. Moreover, some companies which may have previously prohibited the receipt of attachments for fear of obtaining a virus may now permit users to receive attachments, which increases the productivity of employees.

The converting process 340 may further use the type of object identified by the printer driver, such as for example text, graphics, photograph, business graphic, black/white, color, etc., to identify different portions of the output. With the identification of different portions of the output, different compression routines may be applied to different objects in such a manner to increase the encoding efficiency while maintaining a quality resulting output. For example, a first compression routine may be used on the graphics while a second compression routine may be used on the text. This results in a potentially increased file compression which saves storage space.

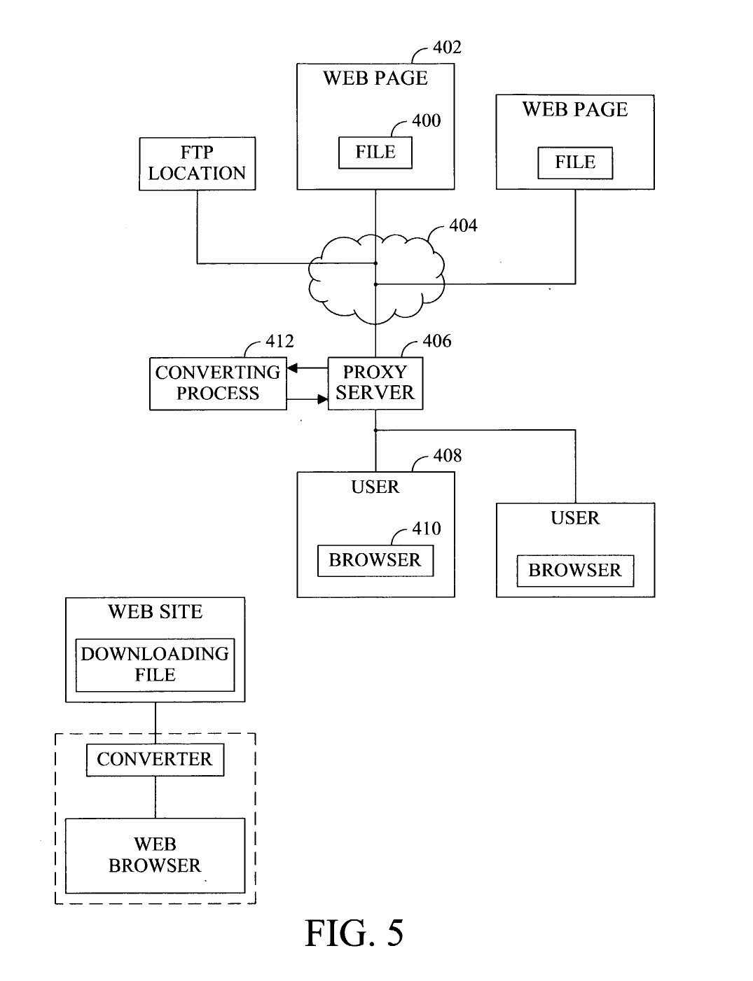

After further consideration the present inventor came to the realization that files, such as Microsoft Word files, may be directly downloaded by the user from a network location, such as a web site or a ftp location on the Internet. These downloaded files, which may be executed or otherwise opened by the user may result in the activation of a viruses. The downloading of files is generally considered one of the inherent risks in network management for which traditional virus scanning software was the only potential safeguard, with its inherent limitations. In particular, the principal danger results from files downloaded or otherwise obtained from locations outside of the corporate network of the particular user, such as the Internet. After consideration of this traditional limitation, the present inventor came to the further realization that the file format conversion technology may be applied in a similar manner with a proxy server, such as a HTTP proxy for the Internet. Referring to FIG. 5, a file 400 may be located somewhere on the network 404, such as a web page 402 or any other network location. When transferring the file 400 across the network 404 the file may be cached by or otherwise passed through a proxy server 406. The proxy server 406 provides web pages or other data to the user 408. The user 408 may view the web pages or documents by using a browser 410 or other interface, such as shown in FIG. 7.

When the proxy server 406 detects, or otherwise, that the file(s) 400 is received by the proxy server 406, the file is passed to a converting process 412, which in a similar manner to the converting process 340, converts the file 400. The converted file 400 is then provided to the user, which may then be viewed by the user 408. In this manner, the user 408 may download or otherwise obtain files from network locations in a manner that is free from inadvertently obtaining a virus. It is to be understood that the file conversion process may be implemented by or in association with any type of proxy server at any location interconnected to the network 404. Further, the proxy server may be implemented by the user 408 to accomplish the file conversion process. This file conversion process eliminates the likelihood of inadvertently obtaining a virus. In addition, the file conversion process may be implemented in any manner, where the transfer of a document (e.g., file) from a first location to a second location, typically eventually for a destination user is converted, preferably by, at least in part, a printing function.

After considering the proxy server embodiment and the e-mail embodiment, the present inventor came to the file conversion process may be applied in a much more general manner for in-stream document conversion. This provides a powerful tool for reformatting documents, namely by using a printing process for the document, created by other programs.

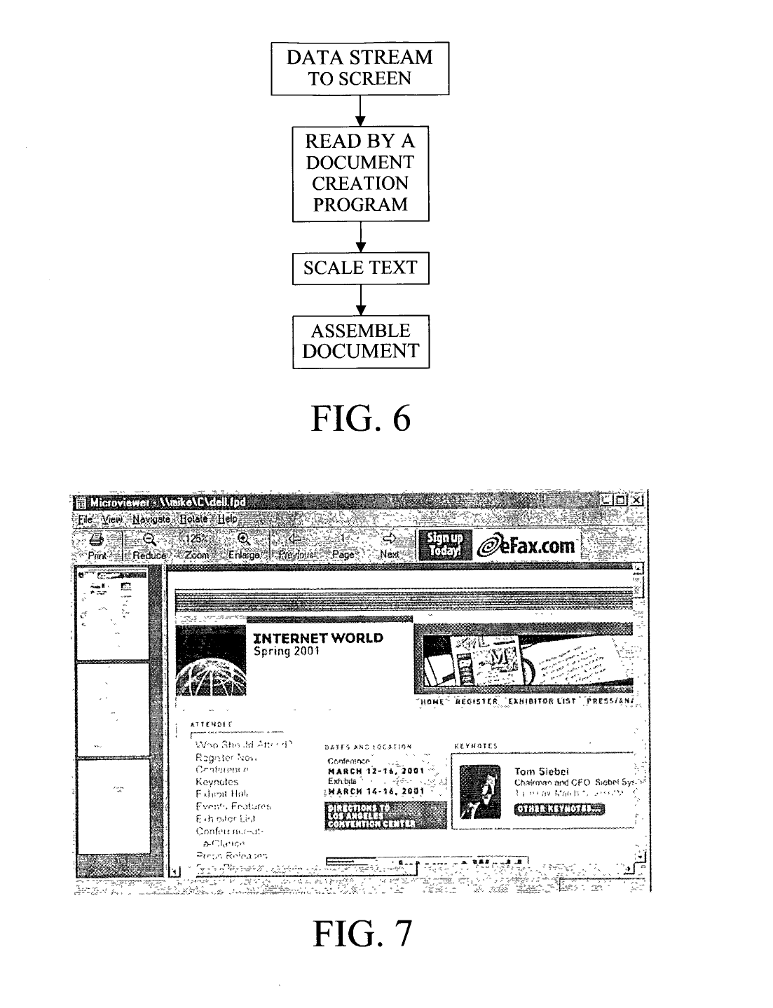

When an operating system such as Windows draws data to the screen image buffer, it does so using an application programming interface that is similar to the application programming interface used for printing. Frequently, web page designers and other artists desire to capture all or a portion of the displayed screen image in a file. The traditional technique for capturing screen images is to convert the screen image to a graphics file format, such as a BMP, GIF, or JPEG. Graphic file formats are not suitable for text based searches, tend to be relatively large, and scaling the size of the graphic file results in excessive distortion of the image depicted therein. Further, screen fonts for applications tend to be made out of very small single pixel characters, that when converted to a bit map, result in an image that is not suitable for reducing the image size without resulting in an unreadable image because the text was created out of single pixel draw strokes. Referring to FIG. 6, the present inventor came to the realization that a rendering based conversion technique may be applied to all or a portion of the screen image. The data stream of commands from an application program or operating system to the screen are read by a document creation program. This data stream includes data representative of text and the size thereof, graphics, etc., and/or the positioning of the text and graphics. The text may then be scaled to the appropriate size by any technique, such as simply scaling the font size and/or font type. Thereafter, the text, graphics, etc. are assembled into a completed document or otherwise an image that may be viewed or otherwise subsequently used.

In another embodiment, an outbound e-mail may be processed to determine if an attachment is associated therewith. If an attachment is associated therewith, then the attachment is converted to a common data format, such as by printing the attachment. Thereafter, the original attachment is replaced by the converted attachment. In this manner, the likelihood of transmitting a virus is reduced and the likelihood of the destination user being able to view the associated attachment is significantly increased.

In another embodiment, inbound and/or outbound e-mail messages may be modified to include a link to the location of where to download an appropriate viewer of the converted document. Installation of the viewer is preferably done with a single-click.

What is claimed is:

1. A method of transmitting an e-mail message with an associated attachment comprising:
(a) transmitting said e-mail message together with said associated attachment in a first format addressed to a destination through a network;
(b) receiving said e-mail and said associated attachment and converting said attachment from said first format to a second format using, at least in part, a printing function; and
(c) said destination receiving said e-mail and said converted associated attachment.

2. A method of transmitting e-mail messages with an associated attachment comprising:
(a) transmitting a first e-mail message together with an associated first attachment in a first format addressed to a destination through a network;
(b) receiving said first e-mail message and said associated first attachment and converting said first attachment from said first format to a second format using;
(c) transmitting a second e-mail message together with an associated second attachment in a third format, where said third format is different than said first format, addressed to a destination through a network;
(d) receiving said second e-mail message and said associated second attachment and converting said second attachment from said third format to said second format;
(e) said destination receiving said first e-mail message and said converted associated first attachment, and said destination receiving said second e-mail message and said converted associated second attachment.

3. A method that includes an e-mail message with an associated attachment in a first file format comprising:
(a) receiving said e-mail with said associated attachment at an e-mail server, where said e-mail originated from an originating user which does not use said e-mail server as an outgoing e-mail server;
(b) converting said attachment from said first file format to a second file format; and
(c) providing said e-mail and said converted attachment to a destination.

4. A method of transmitting an e-mail message with an associated attachment comprising:
(a) transmitting said e-mail message together with said associated attachment in a first format addressed to a destination through a network;
(b) receiving said e-mail and said associated attachment and converting said attachment from said first format to a second format in a manner that is independent of the destination;
(c) said destination receiving said e-mail and said converted associated attachment;
(d) viewing said converted attachment which is representative of viewing said non-converted attachment with an appropriate viewing system.

5. A method of transmitting an e-mail message with an associated attachment comprising:
(a) transmitting said e-mail message together with said associated attachment in a first format addressed to a destination through a network;
(b) receiving said e-mail and said associated attachment and converting said attachment from said first format to a second format in a manner that is free from consideration of a designated user's device characteristics;
(c) said destination receiving said e-mail and said converted associated attachment;
(d) viewing said converted attachment which is representative of viewing said non-converted attachment with an appropriate viewing system.
